(19) United States
(12) Patent Application Publication
(10) Pub. No.: US 2022/0037727 A1
(43) Pub. Date: Feb. 3, 2022

(54) BATTERY MODULE FIXING

(71) Applicant: McLaren Automotive Limited, Woking (GB)

(72) Inventors: Sunoj Cherian George, Woking (GB); James Douglas McLaggan, Woking (GB); Elie Talj, Woking (GB)

(21) Appl. No.: 17/277,257

(22) PCT Filed: Sep. 17, 2019
(86) PCT No.: PCT/GB2019/052604

§ 371 Date: Mar. 17, 2021

(30) Foreign Application Priority Data
Sep. 18, 2018 (GB) 1815184.5

(51) Int. Cl. H01M 50/213; H01M 10/613; H01M 10/625; H01M 10/6556; H01M 10/6567; H01M 10/643; H01M 50/262

(52) U.S. Cl. CPC H01M 50/213; H01M 10/613; H01M 10/625; H01M 2220/20; H01M 10/6567; H01M 10/643; H01M 50/262; H01M 10/6556

(57) ABSTRACT

A battery module comprising a cell tray defining a plurality of cell holes for holding cells and a fixing hole for securing the battery module to a vehicle. The battery module further comprising a plurality of cells in the cell holes and a housing enclosing the cells, wherein the fixing hole is accessible outside the region enclosed by the housing.

This invention relates to a battery to be installed in a vehicle, in particular the means in which the battery is secured to the vehicle.

An increasing number of vehicles are being manufactured, wherein the vehicle uses electrical energy from a battery installed in the vehicle as an energy source. The vehicle could be an electric vehicle or a hybrid vehicle.

In such vehicles the power that can be provided by the battery is vital in determining the performance of the vehicle. The power to weight ratio of the battery is therefore something that vehicle designers are trying to optimise. This can clearly be done either by increasing the power generated for a given weight or by reducing the weight for a given power output, or most likely a combination of the two. Thus, it is desirable for the battery to comprise a minimal number of parts in order to minimise the weight of the battery and hence minimise the weight of the vehicle.

Furthermore, to maximise the vehicle's power, it is important that forces are transferred efficiently within the battery installed in the vehicle, to reduce unnecessary energy loss.

Particularly for lightweight high-power vehicles such as supercars, it is desirable that the dominant sound that can be heard from inside or outside the vehicle is the sound produced by the vehicle's engine. It is hence beneficial for the battery to be configured so that unnecessary sounds, such as rattling, are reduced. Such noise reduction further minimises the energy loss of the vehicle and improves its efficiency.

It is therefore desirable to manufacture a battery which can be secured to a vehicle using a lightweight fixing means capable of minimising unnecessary sound and other sources of energy loss of the vehicle.

According to the present invention there is provided a battery module comprising a cell tray defining a plurality of cell holes for holding cells and a fixing hole for securing the battery module to a vehicle, a plurality of cells in the cell holes, and a housing enclosing the cells, wherein the fixing hole is accessible outside the region enclosed by the housing.

The said housing may be mechanically attached directly to the cell tray.

A liquid may be present within the region enclosed by the housing.

The invention also provides a battery module comprising a cell tray defining a plurality of cell holes holding cells, the cell holes extending through the cell tray in a first direction; and a fixing hole suitable for securing the battery module to a vehicle, the fixing hole extending through the cell tray in a second direction, wherein there is an angular offset between the first and second directions.

The angular offset between the first and second directions may be 90°.

The fixing hole may be rotationally symmetrical about a central axis.

The central axis of the fixing hole may be a straight line.

The shortest perpendicular distance between the said central axis of the fixing hole and any of the said plurality of cell holes may be greater than the perpendicular distance between the said central axis of the fixing hole and the nearest outer surface of the battery module.

Both ends of the said fixing hole may be accessible outside the region enclosed by the housing.

The housing preferably forms a liquid-tight enclosure around the said region.

The invention also provides a vehicle comprising the battery module as described above, wherein the fixing hole receives a rigid fixing element which secures the battery module to the vehicle.

One advantage of the battery module described herein is that a single fixing element can be used to secure the battery to a vehicle. The invention reduces energy loss due to unnecessary noise caused by the collisions of multiple parts present in existing securing means. Since the invention allows a single fixing element to directly secure the battery to the vehicle floor, the battery becomes virtually integral to the vehicle floor. This solution reduces energy loss caused by inefficient force transfer between the vehicle floor and the battery. Finally, this solution is advantageous as by enabling the securing means to comprise a minimal number of parts, the weight of the vehicle in which the battery is installed is minimised.

### BRIEF DESCRIPTION OF THE DRAWINGS

FIG. 1 shows a battery.

FIG. 2 shows a battery module from the front.

FIG. 3 shows a battery module from the back.

FIG. 4 shows a cell tray.

FIG. 5 shows a cell tray holding cells.

FIG. 6 shows the busbars and flexible printed circuit of a battery module.

FIG. 7 shows the cells, busbars and module terminals of a battery module.

### DETAILED DESCRIPTION OF THE DRAWINGS

The following description is presented to enable any person skilled in the art to make and use the invention, and is provided in the context of a particular application. Various modifications to the disclosed embodiments will be readily apparent to those skilled in the art.

The general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

### Battery Overview

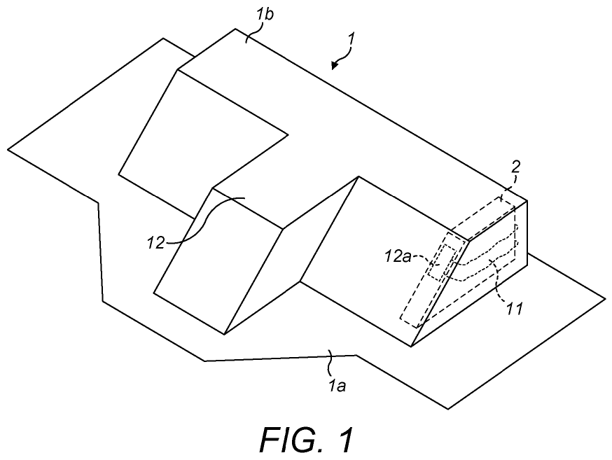

FIG. 1 shows a battery 1 which may comprise a number of identical battery modules 2. The battery modules may be arranged in a row. The battery may comprise any number of battery modules 2. In the example depicted in FIG. 1, one battery module 2 is shown for clarity, but in a preferred example there may be thirteen modules.

The battery may be installed in a vehicle. FIG. 1 shows the battery 1 fixed to a battery floor 1a. The battery floor 1a may be structurally integral to the vehicle in which the battery is installed. For example, the battery floor may be a load bearing component of a vehicle chassis. The battery floor 1a may be configured to be removably fitted to the vehicle so that the battery 1 can be removed from the vehicle. For example, for maintenance or replacement of the battery 1.

The battery 1 may further comprise a battery control unit 12 which protrudes from the row of battery modules. The battery control unit 12 may be electrically connected to one or more module control units 12a. Each battery module 2 may comprise an attached module control unit 12a. The battery control unit 12 may control each battery module control unit 12a. Each battery module control unit 12a may control the activity of the respective attached battery module. Each battery module control unit 12a may receive information concerning the operation of the respective attached battery module. The battery module control units 12a may process that information and feed that information to battery control unit 12.

The battery modules and battery control unit 12 may be enclosed by the battery floor 1a and a battery housing 1b.

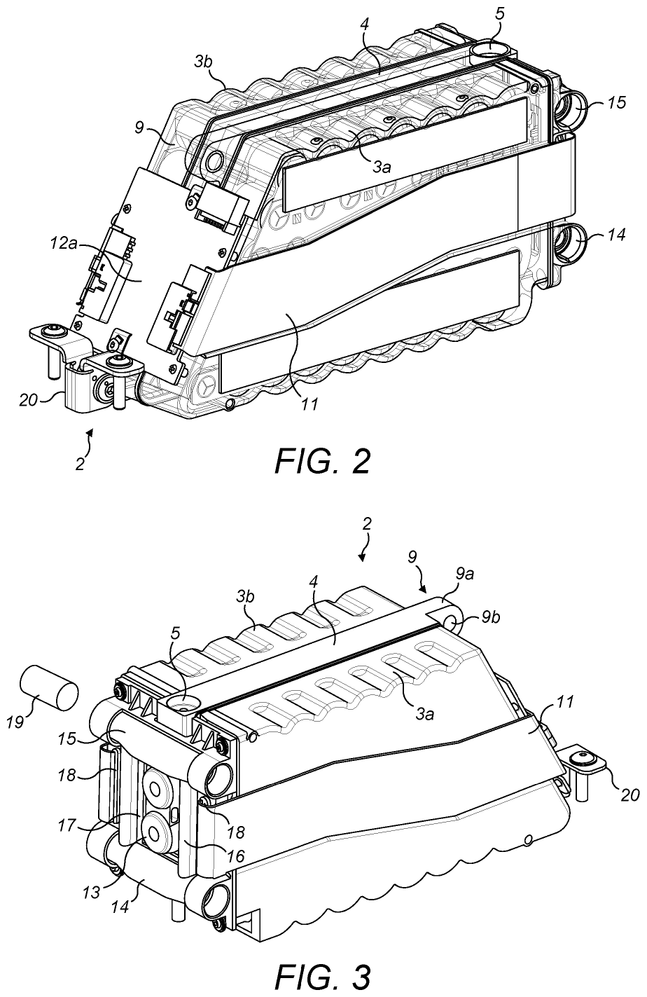

FIG. 2 shows a battery module 2 with a trapezoidal prism shape. The battery module depicted in FIG. 2 comprises a cell tray 4 and a two-part housing 3a, 3b. In FIG. 2, the battery module 2 and the cell tray 4 share a common longitudinal axis.

### Cell Tray

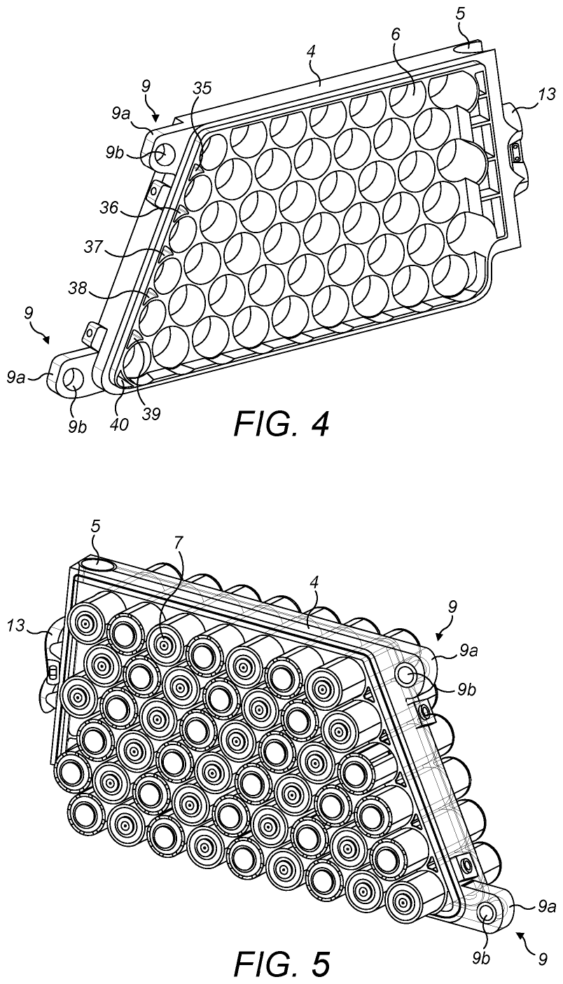

An exemplary cell tray 4 is shown in FIG. 4. The cell tray depicted in FIG. 4 comprises cell holes 6 for holding cells (not shown). Each cell hole 6 may extend through the cell tray in a direction perpendicular to the longitudinal axis of the cell tray. The cell tray may be formed of electrically insulating material.

The cell tray may further comprise a fixing hole 5 configured to receive a fixing element (not shown) for securing the cell tray 4, and hence the battery module 2, to the battery floor (not shown). The fixing hole may be configured for securing the battery module to the vehicle floor. As shown in FIG. 4, the fixing hole may extend through the cell tray. The fixing hole may extend through the entire length of the cell tray. The fixing hole may extend through the entire height of the cell tray. The fixing hole may extend through the entire cell tray in a direction perpendicular to the direction in which each cell hole extends through the cell tray. The fixing hole may extend through the entire cell tray in a direction perpendicular to the longitudinal axis of the cell tray.

FIG. 4 shows the cell tray 4 comprising two fixings 9, each fixing comprising a tab 9a, the tab forming a connection hole 9b. Both fixings are generally positioned in the same plane as the cell tray. Each connection hole 9b may extend through its respective tab 9a in a direction parallel to the direction in which the cell holes 6 extend through the cell tray 4. The cell tray may comprise more than two fixings. The cell tray may comprise a single fixing. Fixings on multiple battery modules may receive one or more common elements so that the battery modules can be secured to one another.

FIG. 5 shows a number of cells 7 being held in the cell holes 6 of the cell tray 4. The cell tray may be configured to hold any number of cells. In the example depicted in FIG. 5 there are forty-eight cells held in respective cell holes 6. Each cell hole may hold one cell.

Resin may be poured into a recessed side of the cell tray. The resin may harden around cells placed in the cell tray so as to secure the cells in the cell tray. Alternatively, each cell 7 may be held in a cell hole 6 by an interference fit between the cell tray 4 surrounding the cell hole and the cell inserted into the respective cell hole.

Each cell hole may extend through the cell tray in a direction perpendicular to the longitudinal axis of the cell tray. In the example cell tray depicted in FIGS. 4 and 5, each cell hole is cylindrical so as to accommodate cylindrical cells. In other examples, each cell hole may be prismatic so as to accommodate prismatic cells.

The length of each cell may be greater than the length of each cell hole. Each cell 7 comprises a positive terminal and negative terminal. When a cell 7 is inserted into a cell hole 6, a length of the cell 7 comprising the positive terminal of the cell may protrude from the cell hole on one side of the cell tray 4 whilst a length of the cell 7 comprising the negative terminal protrudes from the cell hole on the other side of the cell tray. The portion of the cell 7 comprising the positive terminal and the portion of the cell 7 comprising the negative terminal may protrude from opposite sides of the cell tray. The protruding length of the portion of the cell comprising the cell's positive terminal and the protruding length of the portion of the cell comprising the cell's negative terminal may be equal.

The battery module 2 shown in FIG. 2 comprises a two-part module housing 3a, 3b. The housing 3a, 3b may form two enclosed regions which contain the cells 7 held in the cell tray 4. In FIG. 2, one part of the module housing 3a encloses the portions of cells protruding on one side of the cell tray. The second part of the module housing 3b encloses the portions of the cells protruding on the opposite side of the cell tray. In FIGS. 2 and 3, the exterior faces of the battery module 2 comprise faces of the cell tray 4 and the housing 3a, 3b. Alternatively, the housing 3a, 3b may enclose the entirety of the cell tray. In this case, the exterior faces of the battery module would comprise faces of the housing 3a, 3b.

### Cell to Cell Busbars and Flexible Printed Circuit Board

FIG. 7 shows busbars 10 contacting the terminals of multiple cells to form electrical connections between the multiple cells 7. The busbars 10 are formed of electrically conductive material. The busbars 10 may be formed of metal, for example copper or aluminium.

As above, the cell tray 4 (not shown in FIG. 7) fixedly holds cells 7, each cell having a positive terminal and a negative terminal. The busbars 10 may link the cell terminals of any number of cells.

Cells 7 may be arranged in the cell tray 4 so that positive and negative cell terminals protrude from opposite sides of the cell tray. In this way, a current flow path may be created through cells and busbars. For example, the current flow path may “snake” through the battery module. The current flow path may repeatedly intersect the cell tray. The current flow path may repeatedly intersect the longitudinal axis of the battery module. At least some of the cells may be connected in parallel by the busbars 10, meaning that the current flow path passes through multiple cells as the current flow path intersects the cell tray.

Module terminals 13 are shown in FIG. 7. The module terminals 13 are positioned on the back of the battery module and may be integral to the cell tray 4 (not shown in FIG. 7). Module terminals 13 of neighbouring battery modules may be electrically connected, for example, by module to module busbars. The module terminals 13 allow a supply of current to and/or from the cells 7 of the battery module 2.

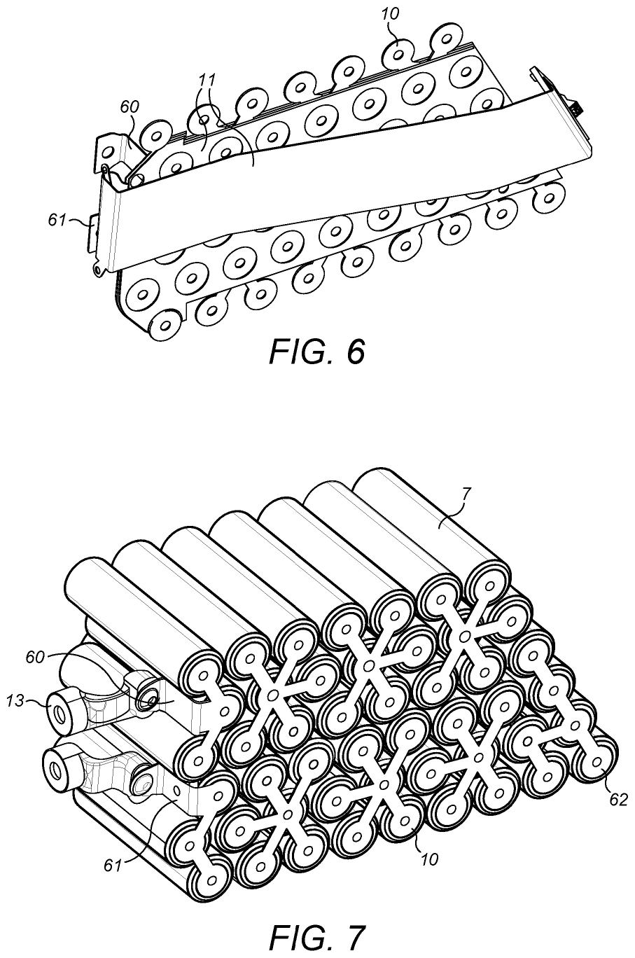

The busbars 10 may be integrated with a flexible printed circuit board (not shown in FIG. 7). FIG. 6 shows the flexible printed circuit board 11 of a battery module. A portion of the flexible printed circuit board 11 is located in the region enclosed by the module housing and another portion of the flexible printed circuit board 11 is wrapped around the exterior faces of both parts of the two-part module housing 3a, 3b, also shown in FIGS. 2 and 3.

The busbars 10 shown in FIGS. 6 and 7 may be integrated with the flexible printed circuit board 11. The busbars 10 may be configured to conduct a high level of current between the cells of the module and the module terminals 13.

The flexible printed circuit board 11 shown in FIG. 6 may further comprise sense wires. The sense wires may be configured to conduct a low current signal. The sense wires in the flexible printed circuit board may be attached to voltage sensors. Each voltage sensor may be capable of determining the voltage at a point on the busbar. Each voltage sensor may be capable of determining the voltage being drawn from a cell. Each voltage sensor may be capable of inferring the voltage being drawn from a cell from a measurement taken of the voltage being drawn from a busbar 10. Each sense wire in the flexible printed circuit board may be capable of communicating voltage measurements from a voltage sensor to a module control unit 12a, shown in FIG. 1. The module control unit 12a may be capable of adapting the activity of the battery module in response to the voltage measurements provided by the sense wire. Each sense wire may be capable of communicating voltage measurements to the battery control unit. The module control unit 12a may be capable of communicating voltage measurements to the battery control unit. The battery control unit 12, also shown in FIG. 1, may be capable of adapting the activity of the battery module in response to the voltage measurements. The battery control unit 12 may be capable of adapting the activity of the battery in response to the voltage measurements.

The sense wires of the flexible printed circuit board 11 may be attached to one or more temperature sensors. A temperature sensor may be capable of determining the temperature of a part of the battery module. Each sense wire may be capable of communicating temperature measurements from a temperature sensor to the module control unit. The module control unit may be capable of adapting the activity of the battery module in response to the temperature measurements provided by the sense wire. Each sense wire may be capable of communicating temperature measurements to the battery control unit. The module control unit may be capable of communicating temperature measurements to the battery control unit. The battery control unit may be capable of adapting the activity of the battery module in response to the temperature measurements. The battery control unit may be capable of adapting the activity of the battery in response to the temperature measurements.

The sense wires may be attached to other types of sensors, for example current sensors, and/or fluid flow sensors.

FIGS. 6 and 7 also show terminal tabs 60, 61 which each of which connect either a positive or a negative end of the busbar to the respective positive or negative module terminal.

### Module Cooling

It is known to supply coolant to regulate the temperature of batteries. In typical batteries, the coolant is confined within coolant jackets or pipes. In such batteries, cells are cooled in areas of the cell which make contact with the jacket or pipe containing the coolant. This is a slow and inefficient cooling method.

In other typical batteries, coolant is not confined by coolant jackets or pipes, but makes direct contact only with the body/centre portion of each cell. In such batteries, the cell terminals are protected so that coolant does not make contact with the cell terminals. Such contact is avoided as it would typically lead to electrical shorting. This is also an inefficient method because the cell terminals, being electrically connected, are often the hottest parts of the cell and yet they are not directly cooled by the coolant.

By contrast, in the battery module described herein, coolant supplied to the battery module 2 makes direct contact with cell terminals, flexible printed circuit board 11, busbars 10, and cell body. The entirety of the cell and connected conducting parts are bathed in coolant. The coolant used is a dielectric oil. Dielectric oils have insulating properties. Cells drenched in dielectric oil are insulated from one another preventing short circuiting between cells. This is an efficient method of regulating cell temperature. Such efficient cooling enables the cells to operate at a higher power and for longer. This means that fewer and/or smaller cells are required to generate the same power as batteries utilising the previously mentioned cooling methods.

FIG. 3 shows a supply coolant conduit portion 14 and a drain coolant conduit portion 15. In the exemplary configuration shown in FIG. 3, the supply coolant conduit portion 14 is positioned in a lower position and the drain coolant conduit portion 15 is positioned in an upper position. Such a configuration reduces the risk of air locks occurring during filling. Alternatively, the supply coolant conduit portion may be positioned in an upper position and the drain coolant conduit portion may be positioned in a lower position.

Both coolant conduit portions may extend along the battery module in a direction orthogonal to the longitudinal axis of the battery module. Both coolant conduit portions may extend along the battery module in a direction orthogonal to the direction in which the fixing hole 5 extends through the cell tray 4. Both coolant conduit portions may extend along the battery module in a direction parallel to the direction in which the cell holes 6 extend through the cell tray 4.

As shown in FIG. 3, the supply coolant conduit portion 14 is linked to an inlet 16 in the battery module so that coolant may be supplied to a region enclosed by the housing of the battery module. The drain coolant conduit portion 15 is linked to an outlet 17 so that coolant may be drained from a region enclosed by the housing of the battery module. Inlet 16 and outlet 17 are openings formed in the module housing. The coolant may be supplied to one of the two regions enclosed by the housing and be drained from the other of the two regions enclosed by the housing, one region being on an opposite side of the longitudinal axis of the cell tray to the other region. The cell tray 4 may comprise through-holes 35 to 40 for allowing the passing of coolant from a respective one of the said regions to the other of the said regions. The through-holes may be located in the cell tray 4 at the end of the cell tray 4 remote from the inlet 16 and outlet 17. The through-holes may be shaped to promote even fluid flow over the cells.

As shown in FIG. 1, battery 1 contains a number of battery modules 2 arranged in a row. When battery modules 2 are positioned in a row, a coolant conduit portion 14 of one battery module aligns with a coolant conduit portion of a neighbouring battery module. The two coolant conduit portions may be connected to one another by a coupler 19, shown in FIG. 3. Couplers 19 form liquid tight connections between coolant conduit portions so that coolant may flow from portion to portion. When supply coolant conduit portions 14 of the battery modules in the row of battery modules are connected by couplers 19, they form a supply coolant conduit 14a which extends along the length of the row of battery modules. When drain coolant conduit portions 14 of the battery modules in the row of battery modules are connected by couplers 19, they form a drain coolant conduit 15a which extends along the length of the row of battery modules.

As shown in FIG. 1, the longitudinal axes of all the battery modules 2 in the row of battery modules of the battery 1, may be parallel to one another. Both coolant conduits 14a, 15a may extend along the row of battery modules in a direction orthogonal to the longitudinal axes of the battery modules in the row of battery modules. Both coolant conduits may extend along the row of battery modules in a direction orthogonal to the direction in which the fixing hole 5 extends through the cell tray 4 of each battery module. Both coolant conduits may extend along the row of battery modules in a direction parallel to the direction in which the cell holes 6 extend through the cell tray 4 of each battery module.

Inlet 16 and outlet 17 may be configured to allow coolant to enter and leave the battery module 2. Inlet 16 and outlet 17 may further act as passages through which the flexible printed circuit boards 11 pass between the interior and exterior of the battery module, as shown in FIG. 3. The inlet 16 and outlet 17 may be the only openings in the two-part housing 3a, 3b of the battery module 2. FIG. 3 shows sealant 18 around the inlet 16 and outlet 17. Sealant 18 ensures that coolant inside the battery module does not leak from the battery module into other parts of the battery.

The method of direct cell cooling described herein also has further advantages in the case that excessive pressure builds up inside a cell. Each cell may comprise a cell vent port. In the case that excessive pressure builds up inside the cell, the cell vent port may be activated, allowing fluids within the cell to escape the cell. The cell vent port may be configured to expel cell fluids in the event that pressure within the cell exceeds a threshold. Upon leaving the cell, the fluids are quenched by the surrounding coolant.

### Battery Fixing

As described above, the battery described herein may comprises one or more battery modules 2. Each battery module may comprise a cell tray 4, the cell tray comprising cell holes 6 configured to hold cells 7. The cell tray 4 described herein has a longitudinal axis. The cell holes may extend through the cell tray in a direction orthogonal to the longitudinal axis. The cell tray may further comprise a fixing hole 5 extending through the cell tray. The fixing hole 5 may be configured to receive a single fixing element for securing the battery to a vehicle. There may be an angular offset between the direction in which the fixing hole extends through the cell tray and the direction in which the cell holes extend through the cell tray. The direction in which the fixing hole extends through the cell tray may be orthogonal to the direction in which the cell holes extend through the cell tray. A housing encloses the portion of the cell tray configured to hold cells forming at least one enclosed region containing cells.

As described above, the battery module may comprise a two-part housing 3a, 3b wherein one part affixes to a face of the cell tray and the other part affixes to an opposite face of the cell tray. One part of the two-part housing 3a, 3b encloses a first region of the battery module containing all cell terminals protruding from a face of the cell tray and the other part of the two-part housing encloses a second region of the battery module containing all cell terminals protruding from an opposite face of the cell tray. The cell tray may form a partition in the battery module, separating the first and second regions. The first region may be on an opposite side of the longitudinal axis of the cell tray from the second region. The two-part housing may not enclose the entire cell tray so that the external walls of the battery module comprise exterior faces of the housing 3a, 3b and exterior faces of the cell tray 4.

A fixing hole 5 extends through the cell tray 4. The fixing hole may extend through the entire length of the cell tray. The fixing hole may extend through the entire height of the cell tray. The fixing hole may extend through the entire cell tray in a direction perpendicular to the direction in which each cell hole extends through the cell tray. The fixing hole may extend through the entire cell tray in a direction perpendicular to the longitudinal axis of the cell tray. The fixing hole 5 is hence accessible outside the regions enclosed by the housing. The fixing hole 5 is configured to receive a single fixing element extending through the cell tray for securing the battery to the vehicle. The fixing hole may be configured for securing the battery module to the vehicle floor. The length of the single fixing element may be greater than the length of the cell tray.

The length of the single fixing element may be greater than the height of the cell tray. The fixing element may be used to secure the battery to the floor of the vehicle. The fixing element may extend through the cell tray. The fixing element may extend through the entire height of the cell tray. The fixing element may extend through the entire length of the cell tray. The battery floor may be structurally integral to the vehicle in which the battery is installed. For example, the battery floor may be a load bearing component of a vehicle chassis. The fixing element can be moved relative to the fixing hole without disturbing the coolant present in the battery module. The fixing element can be moved relative to the fixing hole without affecting the structure of the battery module. That is, the fixing element can be removed from the fixing hole without causing the battery module to disassemble. There may be an angular offset between the direction in which the fixing hole extends through the cell tray and the direction in which the cell holes extend through the cell tray. The fixing hole may extend through the cell tray in a direction orthogonal to the direction in which the cell holes extend through the cell tray. The fixing hole may extend through the cell tray in a direction orthogonal to the longitudinal axis of the cell tray.

The fixing element may be a rigid elongate element, for example a bolt, a screw, a rivet, or a pin. The fixing element may be secured to the floor via a screw fit, a nut, or a push fit. It is preferable that the securing of the fixing element is reversible, so that the battery module can be removed from the floor for maintenance or replacement.

When a vehicle is driven reaction forces are generated and exerted on the components of the vehicle, especially during acceleration, braking and cornering. These reaction forces can lead to energy loss, undesired sounds such as rattling between loose components, and even mechanical failures. However, fixing each battery module to the vehicle floor in the manner described herein is particularly energetically efficient. This is because the cell tray is the component that directly supports the mass of the cells (generally the heaviest component in a battery). The cell tray is in turn directly secured by the fixing element to the battery floor, a structurally integral element of the vehicle chassis. Thus, any reaction forces experienced by the battery module, or the cells, are directly transferred, via the cell tray and the fixing element, into the battery floor where the forces can be dissipated into the vehicle chassis.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A battery module comprising:
a cell tray defining:
a plurality of cell holes for holding cells; and
a fixing hole for securing the battery module to a vehicle;
a plurality of cells in the cell holes; and
a housing enclosing the cells;
wherein the fixing hole extends through the cell tray and is accessible outside the region enclosed by the housing.

2. A battery module as claimed in claim 1, wherein the said housing is mechanically attached directly to the cell tray.

3. A battery module as claimed in claim 1, wherein a liquid is present within the region enclosed by the housing.

4. A battery module as claimed in claim 1, wherein the said fixing hole is rotationally symmetrical about a central axis.

5. A battery module as claimed in claim 4, wherein the said central axis of the fixing hole is a straight line.

6. A battery module as claimed in claim 4, wherein the shortest perpendicular distance between the said central axis of the fixing hole and any of the said plurality of cell holes is greater than the perpendicular distance between the said central axis of the fixing hole and the nearest outer surface of the battery module.

7. A battery module as claimed in claim 1, wherein the cell holes extend through the cell tray in a first direction, the fixing hole extends through the cell tray in a second direction, and wherein there is an angular offset between the first and second directions

8. A battery module as claimed in claim 7, wherein the said angular offset between the first and second directions is 90°.

9. A battery module as claimed in claim 1, wherein both ends of the said fixing hole are accessible outside the region enclosed by the housing.

10. A battery module as claimed in claim 1, wherein the housing forms a liquid-tight enclosure around the said region.

11. A vehicle comprising the battery module as claimed in claim 1, wherein the fixing hole receives a rigid fixing element which secures the battery module to the vehicle.

12. A battery module as claimed in claim 2, wherein a liquid is present within the region enclosed by the housing.

13. A battery module as claimed in claim 12, wherein the said fixing hole is rotationally symmetrical about a central axis.

14. A battery module as claimed in claim 6, wherein the cell holes extend through the cell tray in a first direction, the fixing hole extends through the cell tray in a second direction, and wherein there is an angular offset between the first and second directions.

15. A battery module as claimed in claim 2, wherein both ends of the said fixing hole are accessible outside the region enclosed by the housing.

16. A battery module as claimed in claim 8, wherein both ends of the said fixing hole are accessible outside the region enclosed by the housing.

17. A battery module as claimed in claim 3, wherein the housing forms a liquid-tight enclosure around the said region.

18. A battery module as claimed in claim 8, wherein the housing forms a liquid-tight enclosure around the said region.

19. A vehicle comprising the battery module as claimed in claim 6, wherein the fixing hole receives a rigid fixing element which secures the battery module to the vehicle.

20. A vehicle comprising the battery module as claimed in claim 8, wherein the fixing hole receives a rigid fixing element which secures the battery module to the vehicle.
